(19) United States
(12) Patent Application Publication
(10) Pub. No.: US 2012/0286151 A1
(43) Pub. Date: Nov. 15, 2012

(54) Devices and Methods for Analyzing Surfaces

(75) Inventors: Joseph A. Jarrell, Newton Highlands, MA (US); Michael P. Balogh, Rehoboth, MA (US)

(73) Assignee: WATERS TECHNOLOGIES CORPORATION, Milford, MA (US)

(21) Appl. No.: 13/105,605

(22) Filed: May 11, 2011

(51) Int. Cl. H01J 49/26; H01J 49/10

(52) U.S. Cl. 250/282; 250/288

(57) ABSTRACT

Embodiments of the present invention are directed to devices and methods for performing an analysis of a sample having a sample surface. The device and method feature a frame element affixed to a sample holder, jet element and a charged particle analyzer having an ion receiving orifice. The jet element directs a jet of gas towards the sample surface held by said sample holder focused on less than 2.0 mm² of the sample surface. Ions formed by the electrode means are received by a charged particle analyzer having a ion receiving orifice for receiving one or more sample ions and performing a charged particle analysis with respect to the sample surface. The sample holder moves with respect to the jet element, and charged particle analyzer to permit scanning of a sample surface.

### FIELD OF THE INVENTION

This invention relates to devices and methods for analysing surfaces. The surfaces may comprise the sample or have a composition which is to be analyzed distributed about the surface.

### BACKGROUND OF THE INVENTION

For the purpose of the present discussion, the following terms will be used as defined below.

As used herein the term “analyte” refers to a composition or compound that one desires to detect the presence or absence of or the relative amount. As used herein, the term “surface” will be used to denote a solid form having a terminal surface at the interface of the solid and the atmosphere. The term “sample” is used to denote a material, composition or thing which is to be analysed.

There are several techniques for analyzing samples which have surfaces or which present samples on a surface. One method, atmospheric pressure surface analysis probe (ASAP) analysis, involves the desorption of analytes by a stream of a heated inert gas and their subsequent ionization by means of a corona discharge established in a chamber in which the surface bearing the analytes is disposed.

ASAP analysis and other methods generate ions from a relatively large area of a surface, typically at least several mm². These methods cannot therefore be used to provide detailed spatial information about the distribution of any particular analyte on the surface. Currently, the only mass spectrometric techniques capable of providing detailed spatial information are secondary ion mass spectrometry (SIMS) and certain types of matrix-assisted laser desorption ionization (MALDI). Both require the analyte bearing surface to be disposed in a region of high vacuum rather than atmospheric pressure, which limits their range of applicability. Atmospheric pressure MALDI (AP-MALDI) has been used in experiments to produce spatial information, but has not yet been developed sufficiently to result in a commercial product. The term “atmospheric pressure” is used to distinguish over techniques which are generally regarded in the art as vacuum techniques. The range of pressures encompassed by the term may be from about 100-1500 mbar. In many embodiments the range may be smaller, say from about 500-1200 mbar. In many practical embodiments, the range may be between about 900 and 1100 mbar. Often, the pressure will be that subsisting in the environment of the surface when a pump is not used to reduce the pressure.

A need therefore exists for apparatus and methods capable of providing detailed spatial information relating to analytes present on a surface at atmospheric pressure.

### SUMMARY OF THE INVENTION

Embodiments of the present invention feature apparatus and methods capable of providing detailed spatial information relating to analytes potentially present on a surface. One embodiment of the present invention directed to a device for performing an analysis of a sample having a sample surface. The device has a frame element, sample holder, a jet element, an electrode and a charged particle analyzer having an ion receiving orifice. The frame element is affixed to the sample holder, jet element and charged particle analyzer having an ion receiving orifice. The sample holder is for receiving a sample having one or more sample surfaces for analysis. The sample holder is held in a position with respect to the jet element and the ion receiving orifice by the frame element. The jet element is for directing a jet of gas towards the sample surface held by the sample holder. The jet element is attached to and held in position with respect to the sample holder by the frame element. The jet element produces a stream of gas focused on less than 2.0 mm² of the sample surface, and even more preferably, less than 1.0 mm². The jet element has a conduit having at least one wall defining an interior conduit surface defining a passage for gas. The conduit is constructed and arranged to be placed in fluid communication with a gas source and has a gas heating element for heating the gas forming a stream. The electrode means is for generating ions from at least one of the group comprising gas molecules forming the stream, gas molecules leaving the sample surface, and molecules from the sample surface to form one or more sample ions. The electrode means is affixed to at least one of the frame element and jet element to allow the ions to be received in the receiving orifice of a charged particle analyzer allowing the charged particle analyzer to analyse the ions relating to the sample surface.

A preferred electrode means is a corona discharge electrode. The corona discharge electrode can be affixed to or integral with the jet element. For example, without limitation, one embodiment of the present invention features a corona discharge electrode affixed to the interior surface of the conduit of the jet element. A further embodiment of the present invention features a corona discharge electrode affixed to the frame element.

The gas heating element is preferably selected from the group comprising peltier devices, electrical resistance elements, heated jackets and the like. A preferred heating element is a electrical resistance element. Electrical resistance elements include wire coils, electrical resistance tape and electrical resistance wires. A preferred electrical resistance element is fixed in a position in the about the interior conduit surface of the conduit. In the alternative, the electrical resistance element is disposed on an exterior surface of the jet element. For example, without limitation, one jet element preferred jet element is a capillary having a electrical heating wire or tape wrapped about its exterior surface.

Preferably, the frame element holds the electrode means in a constant position with respect to the ion receiving orifice and the jet element. A preferred frame element, in this regard, has a head piece in which the ion receiving orifice, jet element and electrode means are held. The ion receiving orifice, jet element and electrode means are preferably maintained approximately 0.01 to 0.3 cm from the surface of the sample. Preferably, the ion receiving orifice, jet element and electrode means are maintained approximately 0.2 to 1.5 cm from each other. A preferred jet element has a jet opening and said interior wall of said passage narrows to focus the gas stream.

Preferably, the sample holder moves with respect to the jet element and ion receiving orifice to allow a first area of a sample surface to receive a stream of gas and produce one or more ions during a first time period and at least a second area of a sample surface to receive a jet and produce one or more ions during a second time period. The data relating to the various times and area form a scan of the sample surface. Preferably, sample holder moves in at least two dimensions, and more preferably, three dimensions.

Preferably, the frame maintains the position of the surface to be analyzed, the jet element and ion receiving orifice in a close relationship, preferably, within 2.0 mm² of each other. Preferably, the device further comprises computer means in signal communication with the sample holder, the jet element and the charged particle analyzer. The computer means receiving data indicative of the sample from the charged particle analyzer and relates the data to the first area or the at least second area as the sample holder assumes different positions. As used herein, the term “computer means” refers to computer processing units (CPUs), including by way of example, personal and mainframe computers, servers, internal CPUs and the like. As used herein, the term “signal communication” refers to being wired, electro-magnetic signals, optical and infrared signal communications.

A preferred charged particle analyzer is a mass spectrometer.

A further embodiment of the present invention is directed to a method of analyzing a sample having a sample surface. The method comprises the step of holding the sample in a sample holder to expose at least one sample surface. Next, the method includes the step of directing a jet of heated gas on said sample surface to form a first area having an area not greater than 2.0 mm².

Next, ions are created from at least one of the heated gas directed on the surface, a heated gas leaving the surface and one or more ions from molecules from the sample, by corona discharge. Next, these ions are received in a opening of a charged particle analyzer to form an ion analysis of the first area.

Preferably, the method further comprises the step of moving the sample holder with respect to the jet of gas and the opening of the charged particle analyzer to form at least one second area of the sample to produce a scan of the sample surface.

These and other features and advantages will be apparent to those skilled in the art upon viewing the drawings, summarised in text below, and reading the detailed description of the invention that follows.

### BRIEF DESCRIPTION OF THE DRAWINGS

FIG. 1 is a drawing of an embodiment of the invention comprising a tubular member and having an electrode external to it;

FIG. 2 is a drawing of an embodiment of the invention having an electrode internal to the tubular member;

FIG. 3 is a flow diagram of an embodiment of a method according to the invention; and

FIG. 4 is a drawing of an embodiment having a heater disposed inside the tubular member.

### DETAILED DESCRIPTION OF EMBODIMENTS OF THE INVENTION

Preferred embodiments of the present invention will now be described in detail with respect to apparatus and methods capable of providing detailed spatial information relating to analytes potentially present on a surface. The description that follows describes the inventors best mode at the time of this writing. Those skilled in the art will recognize that the devices and methods described are capable of being modified and altered without departing from the teaching herein. Therefore, this detailed description should not be considered limiting.

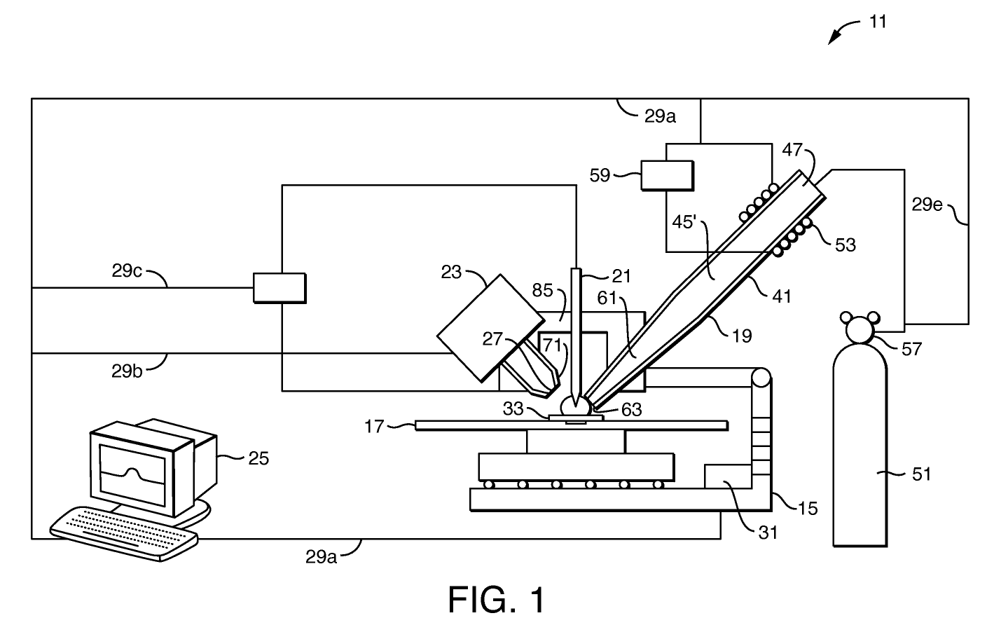

An embodiment of the present invention directed to a device for performing an analysis of a sample having a sample surface, generally designated by the numeral 11, is depicted in FIG. 1. The device 11 has the following major components: a frame element 15, sample holder 17, a jet element 19, an electrode 21, a charged particle analyzer 23 and computer means 25.

As used herein, the term “computer means” refers to computer processing units (CPUs) which are internal to the device 11 or linked by signal communication means to external CPUs. The term includes personal computers, mainframe computers, servers, and handheld devices. As used herein, the term “signal communication” refers to wired together, or able to pass data or command instructions by wireless means such as radio, electro-magnetic transmissions and reception, infra red and other photo-communication devices. Computers, CPUs, and signal communication devices and the like are available from numerous venders. As depicted, the computer means 25 is in signal communication with the frame element 15, jet element 19, electrode 21 and charged particle analyzer 23 via signal communication device 29a through 29e.

The charged particle analyzer 23 has an ion or charged particle receiving orifice 27. A preferred charged-particle analyzer 23 comprises a mass spectrometer or an ion mobility analyzer. Such analyzers are well known and may comprise, by way of example, without limitation, quadrupole, time-of-flight, magnetic sector or ion trap mass spectrometers, preferably having a system of ion guides/and or traps to permit it to receive ions at atmospheric pressure. Charged particle analyzers 23 are well known in the art and available from several venders, including Waters Corporation, Milford, Mass., USA.

The frame element 19 is affixed to the sample holder 17, electrode 21, jet element 19 and a charged particle analyzer 23. The frame element 19 has motor means 31 for moving the sample holder 17 with respect to the jet element 19, electrode 21 and charged particle analyzer 23. The motor means 31 is one or more electrically powered motors such as a stepper motor [not shown] mechanically linked through screws, gears and linkages [not shown] is conventional manner to move the sample holder 17 and the sample, generally designated by the numeral 33, placed thereon.

The position of the sample 33 held by the sample holder 17 with respect to the jet element 19, electrode 21 and ion receiving orifice 25 is controlled the by computer means 25. Computer means 25 is programmed to move the sample and relate the position of the sample and the area of the sample receiving a stream of gas to data from the charged particle analyzer 23 to generate a scan comprising a plurality of sample areas.

A preferred sample holder moves in at least two directions, for example about a x and y axis, and more preferably, three directions, for example about an x-y-z axis. A preferred sample holder permits rotation to allow the sample 33 to receive a stream of gas at different angles.

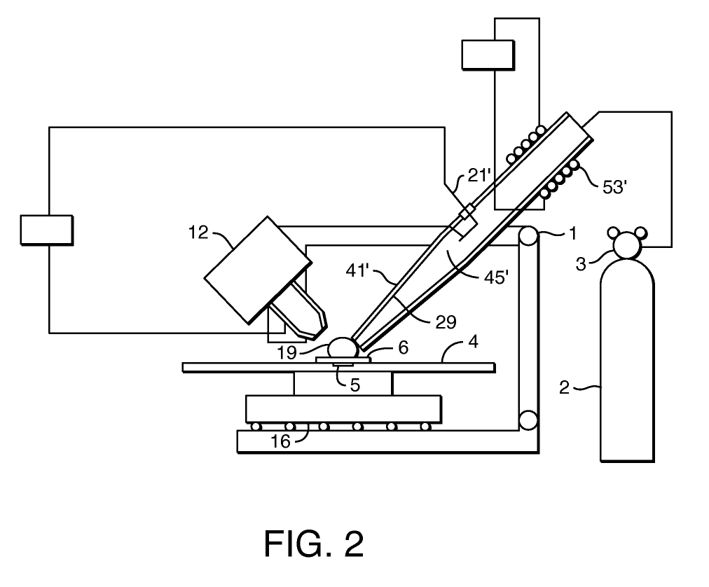

Those skilled in the art will recognize that the sample holder 17 may take several forms. As depicted in FIGS. 1 and 2, the sample holder 17 is a simple platform for placing a sample having at least one sample surface. However, the sample holder may comprise sticky surfaces, clamps, holding vessels and the like [not shown]

The jet element 19 is for directing a jet of gas towards the sample 33 held by the sample holder 17. The jet element 19 produces a stream of gas focused on less than 2.0 mm² of the sample surface, and even more preferably, less than 1.0 mm². The jet element 19 has a conduit 41 having at least one wall 43 defining an interior conduit surface 45 defining a passage 47 for gas and an exterior surface 49. The conduit 41 is constructed and arranged to be placed in fluid communication with a gas source 51. Jet element 19 receives gas from a gas source 51 via a flow regulator 57 in signal communication with computer means 25. Preferred gases are inert, such as nitrogen, helium, argon, or neon. A trace reagent gas, for example water vapor or ammonia, may be added to assist formation of ions from the analyte molecules, as is sometimes done in prior atmospheric pressure ionization sources.

Jet element 19 has a gas heating (or cooling) element 53 for controlling the temperature of the gas flowing through passage 47. The gas heating (or cooling) element 53 is preferably selected from the group comprising peltier devices, electrical resistance elements, heated or cooling jackets and the like [not shown]. Electrical resistance elements include wire coils, electrical resistance tape and electrical resistance wires. The electrical resistance element 53, as shown in FIG. 1, is disposed on an exterior surface 49 of the jet element 19.

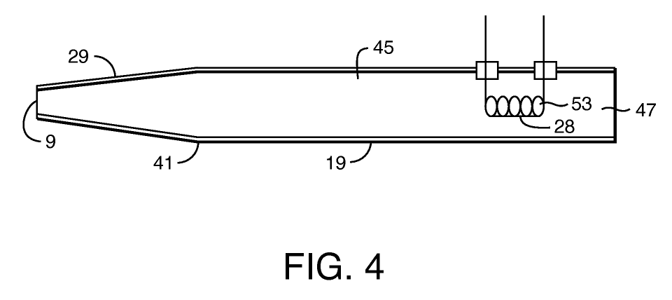

In the alternative, the electrical resistance element 53 is fixed in a position in the about the interior conduit surface 45 of the conduit 41 as best seen in FIG. 4. Such an arrangement may improve the efficiency of heating the flow of gas, but is more likely to cause contamination of the gas. The heater electrical resistance element 53 may also be damaged by corrosive additives which may be added to the gas. Suitable materials for the electrical resistance element 53 may comprise platinum, gold, or alloys such as Nichrome or Kanthal.

Jet element 19 aerodynamically focuses gas on to a limited area of the surface of a sample 33. A preferred jet element 19 is a capillary having a electrical resistance element 53 in the form of a heating wire or tape wrapped about its exterior surface 49 which wire or tape is powered by a suitable power supply 59. The heating of the heating element 53 is controlled by computer means 25.

A preferred gas heating (or cooling) element 53 heats gas to a temperature between 20 and 700° C. The temperature may be selected by adjusting the power fed to the heater so that the maximum efficiency of desorption of the analyte is obtained, but will be limited by the possibility of thermal decomposition. The optimum temperature used will therefore be dependent on the nature of the analyte. In the case of analytes which are thermally unstable, it is possible to cool the substrate which comprises the surface 4 and use relatively low temperatures of the gas. Cooling of the surface may also be useful if it is desired to freeze a solution comprising analytes on the surface.

The conduit 41 has an internally tapered portion 61 proximal to an exit orifice 63. This geometry confines the flow of gas to a limited, defined area of the sample surface. One or more analytes [not shown] may be deposited on the sample surface or the surface itself may be the object of the analysis.

Jet element 19 is preferably made of a material having a low thermal conductivity, for example fused silica or ceramic. A preferred jet element 19 is manufactured from a length of tubing drawn down to form an internally tapered portion 61 and an exit orifice 63 of between 1 and 10 micron in diameter. The size of the area of the sample 33 from which the analyte may be desorbed is determined by the diameter of exit orifice 63, the distance between the exit orifice 63 and the surface of the sample 33, and the nature of the tapered portion 61. An exit orifice 63 with a small diameter will direct gas on a smaller area of the sample and therefore will have greater spatial resolution than exit orifices 63 with larger diameters.

Gas emerging from the exit orifice 63 diverges; thus, the shorter the distance between the exit orifice 63 and the surface of sample 33, the smaller will be the r area to which the gas flow is directed and the greater will be the spatial resolution. A preferred diameter of exit orifice 63 is between 1 and 10 microns and the distance between the exit orifice 63 and the surface of the sample is between 0.1 and 1.0 mm. The area of the sample from which ions or charged particles are generated is less than 1 mm², and preferably, the use of the smaller diameters and distances limits the area to less than 0.1 mm².

The electrode means 21 is for generating ions from at least one of the group comprising gas molecules forming the stream, gas molecules leaving the sample surface, and molecules and particles from the sample surface to form one or more sample ions and/or charged sample particles. The electrode means 21 is affixed to at least one of the frame element 19 as shown in FIG. 1, and jet element 19, as best seen in FIG. 2. Ions and charged particles formed from the sample are received in the receiving ion orifice 27 of the charged particle analyzer 23.

A preferred electrode means 21 is a corona discharge electrode. The corona discharge electrode can be affixed to or integral with the jet element 19 as depicted in FIG. 2 or as a separate element as depicted in FIG. 1. Referring now to FIG. 1, electrode means 21 is a sharply pointed metallic rod affixed to the frame element 19, disposed adjacent to the exit orifice 63 of the jet element 19 and the sample 33. This electrode means 21 is used to generate a corona discharge adjacent to the sample 33. A potential difference is maintained between the electrode means 21 and a counter electrode 71 which in the FIG. 1 embodiment comprises the entrance of a charged-particle analyzer 23. In the alternative, the counter electrode may comprise conductive portions of the sample holder 17, a further metallic rod [not shown] or portions of an enclosure [not shown]. An electrode power supply 73 in electrical communication with counter electrode 71 electrode means 21 creates an electrical potential between electrodes.

The electrode means 21 results in the generation of charged particles from the desorbed analyte molecules in the discharge by an atmospheric pressure ionization mechanism. These charged particles are characteristic of the analyte present on or in the area to which the gas is directed on the sample 33. The chemical mechanism by which the charged particles are formed is thought to be similar to that present in conventional atmospheric pressure ionization sources used in mass spectrometry. It should be noted that these charged particles are formed in the gas phase from neutral molecules of the analyte which have been desorbed by the action of thermally excited neutral molecules of hot gas from the jet element 19. This method contrasts with the mechanism of DESI (in which desorption is a result of bombardment with charged particles) and DART (in which desorption is a result of bombardment with electronically excited metastable species having internal energies much higher than the thermal energies imparted by the heater of the invention).

Turning now to FIG. 2, an alternative electrode means 21′ is disposed inside the jet element 19′, downstream of the gas heater 53′. A power supply 59′ is connected between the electrode means 21 and the entrance electrode 71 of the charged-particle analyzer 23. However, alternative counter electrodes can be used, as described above for the case of the FIG. 1 embodiment. Electrode means 21′ produces a corona discharge adjacent to the exit orifice 63′ of the jet element 19′ over a limited area of the surface of sample 33′. The corona discharge generated in this way may be of smaller extent than that produced in the FIG. 1 embodiment, which may increase the efficiency of the generation of charged particles and assist in improving the spatial resolution of the device 11′. The electrode means 21′, as depicted in FIG. 2, is a sharply pointed rod or wire, bent at right-angles and inserted through a hole 81′ in the wall 41′. It may be held in place by a sealant or may be fused into the wall, for example by means of a glass-metal or quartz-metal graded seal.

Returning now to FIG. 1, the frame element 15 maintains the electrode means 21, the ion receiving orifice 27 and the jet element 19 in a constant position with respect to each other. A preferred frame element 15, in this regard, has a head piece 85 in which the ion receiving orifice 27, jet element 19 and electrode means 21 are held. The ion receiving orifice 27, jet element 19 and electrode means 21 are preferably maintained approximately 0.01 to 0.3 cm from the surface of the sample. Preferably, the ion receiving orifice 27, jet element 19 and electrode means 21 are maintained approximately 0.2 to 1.5 cm from each other.

Turning now to FIG. 2, the electrode means 21 is held within the jet element 19 such that the head piece 85 maintains and is affixed to the jet element 19′ and charge particle analyzer 23.

Returning now to FIG. 1, as depicted, the sample holder 17 moves with respect to the jet element 19 and ion receiving orifice 27 to allow a first area of a surface of a sample 33 to receive a stream of gas and produce one or more ions during a first time period and at least a second area of a surface of the sample to receive a jet and produce one or more ions during a second time period. The data relating to the various times and areas form a scan of the sample surface. The frame element 15 maintains the position of the surface of the sample 33 to be analyzed, the jet element 19 and ion receiving orifice 27 in a close relationship, preferably, within 2.0 mm² of each other. Computer means 25 is in signal communication with the frame element 15, the jet element 19 and the charged particle analyzer 23. The computer means 25 can infer the position of the sample 33 from the position of the frame element 15 with respect to the sample holder 17, ion receiving orifice 27, jet element 19 and electrode means 21 or 21′.

The computer means 25 receiving data indicative of the sample from the charged particle analyzer 23, relates the data to the first area or the at least second area as the sample holder 17 assumes different positions to produce a scan or image of the sample surface.

A further embodiment of the present invention, directed to a method of analyzing a sample having a sample surface, will be described with respect to the operation of the device 11 of FIG. 1. The method comprises the step of holding the sample 33 in a sample holder 17 to expose at least one sample surface. Next, a jet or stream of heated gas is directed on the surface of the sample 33 to form a first area having an area not greater than 2.0 mm². Next, ions are created from at least one of the heated gas directed on the surface, a heated gas leaving the surface and one or more ions from molecules from the sample 33, by corona discharge by electrode means 21. Next, these ions are received in an opening 27 of a charged particle analyzer 23 to form an ion analysis of the first area.

The sample holder 17 is moved with respect to the jet of gas from jet element 19 and the ion receiving orifice 27 of the charged particle analyzer 23 to form at least one second area of the sample. The first area data and the at least one second area data are assembled by computer means 25 to produce a scan of the sample surface.

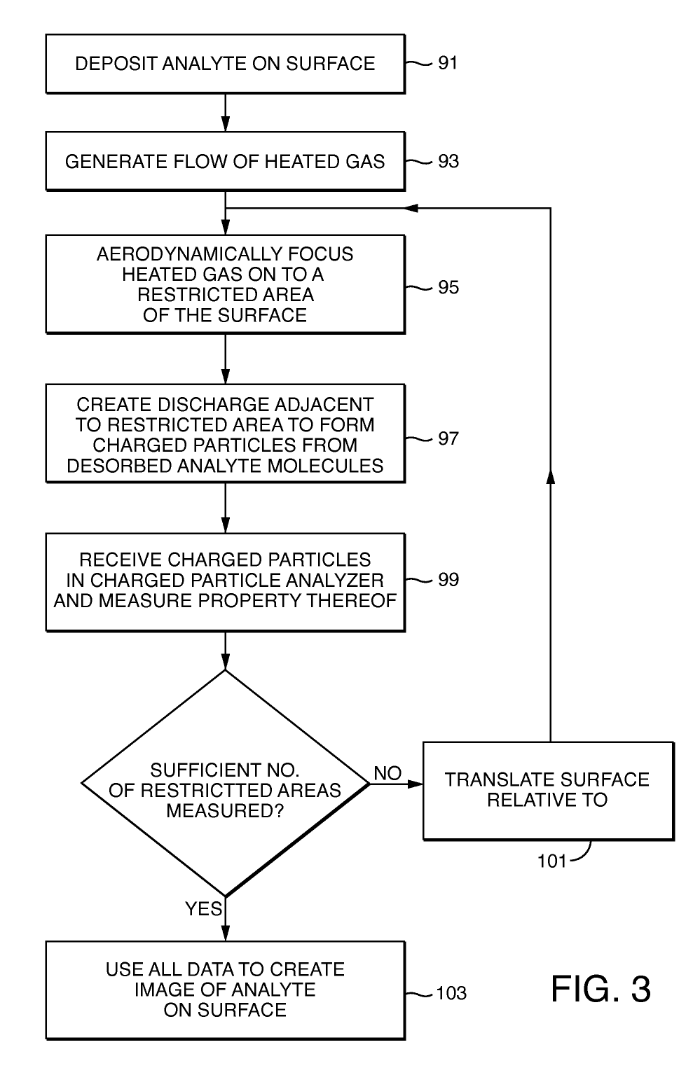

Referring now to FIG. 3, in an embodiment of a method according to the invention, step 91 comprises depositing an analyte a surface. A flow of gas is heated at step 93, and aerodynamically focussed on to an area of the surface at step 95. As the flow of gas impinges on the surface, the aerodynamic focusing results in it being confined to the area, which may be 1 mm² or less. The hot gas may desorb molecules of analytes from the restricted area of the surface. A discharge is created adjacent to the surface (step 97) so that charged particles may be produced from the desorbed molecules.

In other embodiments, the aerodynamic focusing may be such as to limit the area to 0.1 mm² or less.

The flow of gas may be conveyed through a jet element 19 having an exit orifice 63 and being internally tapered so as to cause the aerodynamic focusing of the gas on to the area of the surface 33.

At least some of the charged particles or ions are received and analyzed in a charged-particle analyzer 23, which may be a mass spectrometer or an ion mobility analyzer (for example, step 99).

In order to produce an image of the analyte on the surface, methods according to the invention may additionally comprise moving the surface to a new position so that so that the gas flow impinges on a different area (step 101) and charged particles can be created from the analyte on the different at least one second area. These may then be analysed by the charged-particle analyzer 23. Steps 95-101 may then be repeated, analyzing the charged particles for several different areas in turn, until a sufficient number of areas have been analysed to allow an image based on the property measured by the analyzer to be constructed (step 103).

Thus, preferred embodiments of the present invention have been described with the understanding that such preferred embodiments are capable of being modified and altered without departing from the teaching herein. Therefore, the invention should not be limited to the details present herein but should encompass the subject matter of the claims which follow.

What is claimed:

1. A device for performing an analysis of a sample having a sample surface, comprising:
a.) a frame element affixed to a sample holder, jet element and a charged particle analyzer having an ion receiving orifice;
b.) a sample holder for receiving a sample having one or more sample surfaces for analysis, said sample holder held in a position with respect to said jet element and said ion receiving orifice by said frame element;
c.) a jet element for directing a jet of gas towards said sample surface held by said sample holder, said jet element attached to and held in position with respect to said sample holder by said frame element, said jet element producing a stream of gas focused on less than 2.0 mm² of said sample surface, said jet element comprising a conduit having at least one wall defining an interior conduit surface, said interior surface defining a passage for gas, said conduit constructed and arranged to be placed in fluid communication with a gas source and having a gas heating element for heating said gas forming said stream; and
d.) electrode means for generating ions from at least one of the group comprising gas molecules forming said stream, gas molecules leaving said sample surface, and molecules from said sample surface to form one or more sample ions, said electrode means affixed to at least one of said frame element and jet element to allow said ions to be received in said receiving orifice of said charged particle analyzer; and,
e.) a charged particle analyzer having a ion receiving orifice for receiving one or more sample ions and performing a charged particle analysis with respect to the sample surface.

2. The device of claim 1 wherein said electrode means is affixed to said jet element.

3. The device of claim 2 wherein said electrode means is affixed to the interior surface of said conduit of said jet element.

4. The device of claim 1 wherein said electrode means is affixed to said frame element.

5. The device of claim 4 wherein said frame element holds said electrode means in a constant position with respect to said ion receiving orifice.

6. The device of claim 1 wherein said gas heating element is an electrical resistance element.

7. The device of claim 6 wherein said electrical resistance element is in the about the interior conduit surface.

8. The device of claim 6 wherein said conduit has an exterior surface and said electrical resistance element is about the exterior surface.

9. The device of claim 1 wherein said sample holder moves with respect to said jet element and ion receiving orifice to allow an first area of a sample surface to receive a jet and produces one or more ions during a first time period and at least a second area of a sample surface to receive a jet and produce one or more ions during a second time period to produce a scan of said sample surface comprising said first and at least a second area.

10. The device of claim 9 wherein said sample holder moves in at least two dimensions.

11. The device of claim 9 wherein said frame maintains the position of said surface to be analysed, said jet element and ion receiving orifice are maintained in a close relationship within 2.0 mm² of each other.

12. The device of claim 10 further comprising computer means in signal communication with said sample holder, said jet element and said charged particle analyzer, said computer means receiving data indicative of the sample from said charged particle analyzer and relating said data to the first area or said at least second area as said sample holder assumes different positions.

13. The device of claim 1 wherein said charged particle analyzer is a mass spectrometer.

14. The device of claim 1 wherein said conduit of said jet element has a jet opening and said interior wall of said passage narrows.

15. The device of claim 1 wherein said electrode means is a corona discharge electrode.

16. A method of analyzing a sample having a sample surface comprising the steps:
a.) holding said sample in a sample holder to expose at least one sample surface;
b.) directing a jet of heated gas on said sample surface to form a first area having an area not greater than 2.0 mm²;
c.) creating ions from at least one of said heated gas directed on said surface, a heated gas leaving said surface and one or more ions from molecules from said sample, said ions created by corona discharge;
d.) receiving said ions in a opening of a charged particle analyzer to form an ion analysis of said first area.

17. The method of claim 13 wherein said sample holder moves with respect to said jet of gas and said opening of said charged particle analyzer to form at least one second area of said sample to produce a scan of said sample surface.
